(19) United States
(12) Patent Application Publication
(10) Pub. No.: US 2009/0004497 A1
(43) Pub. Date: Jan. 1, 2009

(54) Wood Preservative Formulations Comprising Rh-287

(76) Inventor: Derek Philip Blow, Berkshire (GB)

Correspondence Address: MILBANK, TWEED, HADLEY & MCCLOY LLP, INTERNATIONAL SQUARE BUILDING, 1850 K STRET, N.W., SUITE 1100, WASHINGTON, DC, 20006, US

(21) Appl. No.: 12/087,106

(22) PCT Filed: Jan. 29, 2007
(86) PCT No.: PCT/US2007/002211

§ 371 Date: Jun. 26, 2008

Related U.S. Application Data
(60) Provisional application No. 60/762,726, filed on Jan. 27, 2006.

(51) Int. Cl. B32B 21/00; A01N 43/80

(52) U.S. Cl. 428/537.1; 106/18.33

(57) ABSTRACT

A wood preservative composition comprising a synergistic combination of RH-287 and one or more co-biocides. Examples of such co-biocides include, fenpropimorph, cyproconazole, imazalil and propiconazole. The efficacy of potential wood preservative compositions can be tested by a simple test provided herein.

### CROSS REFERENCE TO RELATED APPLICATIONS

This application claims priority to U.S. Provisional application No. 60/762,726 filed on Jan. 27, 2006, the disclosure of which is hereby incorporated by reference.

### FIELD OF THE INVENTION

The present invention relates generally to the field of preservation of cellulosic materials, and particularly to 4,5 dichloro-2-n-octyl-4-isothiazolin-3-one containing compositions for the preservation of cellulosic materials.

### BACKGROUND TO THE INVENTION

The treatment of non-durable timber with wood preservatives has been practiced for many years. Some of the more widely used wood preservatives are water based copper containing formulations, tar oil type preservatives and light organic solvent preservatives. Many of the preservative types that have been used successfully over many years are being restricted in their use in some parts of the world due to environmental concerns or health and safety considerations. Thus, there exists a need for the development of wood preservative systems which address the environmental and safety issues.

Much of the treated non-durable timber used in contact with soil has historically been preserved with formulations containing copper and chrome, either alone or in combination with other ingredients such as arsenic. Copper chrome arsenic (CCA) has been widely used to treat timber that is used in many different service situations. Due to restrictions, other copper based systems are being increasingly used in many parts of the world. Many of the widely used replacements for CCA contain copper and one or more organic biocides. One example of a replacement for CCA is the so called Ammoniacal Copper Quaternary (ACQ) preservatives. In some regions there is a desire to have replacements that either have a reduced metal content or are completely metal-free.

In the development of new approaches and compositions for wood preservation, the time required to test a given composition is often considered to be lengthy. Ground contact field trials can vary considerably, but normally exposure sites are chosen such that decay of timber is quite rapid. Other reasons for choosing sites may include particular timber degrading organisms predominating in the area or the soil found in the region having particular characteristics. The trials often compare the performance of stakes treated with one or more experimental treatment with the performance of untreated stakes or stakes treated with one or more reference preservative. After the preparation of the replicate timber specimens, they are placed, partially buried in the ground at the exposure site. At intervals (often 6 months or one year intervals) each timber specimen is examined and inspections commonly continue until all specimens have failed. An example of a field test method is provided in EN 252. Such ground contact field trials may proceed for many years and for this reason more rapid laboratory tests have been developed.

One of the laboratory tests used to evaluate the performance of wood preservatives intended for possible ground contact use is ENV 807. In this test, timber mini-stakes (100×10×5 mm), are exposed in a soil substrate for periods of time up to 32 weeks. The mini-stakes have to be weighed at various times during the test which is time consuming. Additionally, after treatment the mini-stakes need to be dried and leached which with the other operations normally adds over 6 weeks to the period of testing. It is apparent that such a test as described in ENV 807 cannot be completed in less than about 9 months. While this is a great saving in time over that required for most field tests, such lab tests are still time consuming and therefore quicker, less labor-intensive approaches are desirable

### SUMMARY OF THE INVENTION

The present invention relates to a preservative composition for the treatment of wood and other cellulosic materials. The preservative composition comprises 4,5 dichloro-2-n-octyl-4-isothiazolin-3-one and a co-biocide, such that the combination of 4,5 dichloro-2-n-octyl-4-isothiazolin-3-one and the co-biocide have a synergistic effect on the preservation of wood.

### BRIEF DESCRIPTION OF THE DRAWINGS

FIG. 1 is a plot of 4,5 dichloro-2-n-octyl-4-isothiazolin-3-one concentration versus veneer half life.

### DESCRIPTION OF THE INVENTION

The use of 4,5 dichloro-2-n-octyl-4-isothiazolin-3-one , referred to here as RH-287, for protecting cellulosic materials such as wood and cotton is not new. For example the fungicidal properties of RH-287 have been described in documents issued by the International Research Group on Wood Preservation (now known as the International Research Group on Wood Protection). For example document number IRG/WP/3306 by Nicholas et al was produced in 1984 and presents fungal test results for RH-287 and document IRG/WP/3503 by Nicholas et al was produced in 1989 and presents out door exposure test results with RH-287.

In the present invention, it has been found that combining RH-287 with certain other wood protectants improves the performance of RH-287 to a surprising degree, not explained by simply adding the effectiveness of the individual components. The effect of combination is synergistic.

The composition of the present invention comprises RH-287 with a synergistic co-biocide. Synergistic co-biocides include azole-based biocides, such as, for example cyproconazole, propiconazole and imazalil; morpholines, such as, for example, tridemorph and fenpropimorph. Also included are fenarimol, chlorothalonil, copper naphthenate and dichlorophen.

Other names for RH-287 and the synergistic co-biocides which can be used in the composition of the present invention, as well as their chemical biocide type are as follows.

RH-287

Chemical name: 4,5 dichloro-2-n-octyl-4-isothiazolin-3-one or 4,5-dichloro-2-n-octyl-3(2H)-isothiazolone

### CAS # 64359-81-5

Common name: RH-287
Biocide type: isothiazolone

dichlorophen

Common name: dichlorophen
IUPAC name: 4.4′-dichloro-2,2′-methylenediphenol
Chem abstract name: 2,2′-methylenebis [4-chlorophenol]
Biocide type Chlorophenol

fenarimol

Common name: fenarimol
IUPAC name: (±)-2,4′-dichloro-α-(pyrimidin-5-yl) benzhydryl alcohol
Chem abstract name: (±)-α-(2-chlorophenyl)-α-(4-chlorophenyl)-=5-pyrimidinemethanol;
Biocide type: pyrimidinyl carbinol

tridemorph

Common name: tridemorph
IUPAC name: 4-alkyl-2,6-dimethylmorpholine
Biocide type: morpholine

fenpropimorph

Common name: fenpropimorph
IUPAC name: (±)-cis-4-[3-(4-tert-butylphenyl)-2-nethylpropyl]-2,6-dimethyl=morpholine
Chem abstract name: cis-4-[3-[4-(1,1-dimethylethyl0phenyl]-2-methylpropyl]-=2,6-dimethylmorpholine
Biocide type: morpholine

cyproconazole

Common name: cyproconazole
IUPAC name: (2RS,3RS;2RS,3SR)-2-(4-chlorophenyl)-3-cyclopropyl-1-=(1H-1,2,4-trazol-1-yl)butan-2-ol
Chem abstract name: α-(4-chlorophenyl)-α-(1-cyclopropylethyl)-=1H-1,2,4-triazol-1-ethanol
Biocide type: Azole

propiconazole

Common name: propiconazole
IUPAC name: (±)-1-[2-(2,4-dichlorophenyl)-4-propyl-1,3-dioxolan-2-ylmethyl-=1H-1,2,4-triazol
Chem abstract name: 1-[[2-(2,4-dichlorophenyl)-4-propyl-1,3-dioxolan-2-yl]=methyl]-1H-1,2,4-triazole
Biocide type: azole

chlorothalonil

Common name: chlorothalonil
IUPAC name: tetrachloroisophthalonitrile
Chem abstract name: 2,4,5,6-tetrachloro-1,3-benzenedicarbonitrile

Copper naphthenate

Chemical name: Copper naphthenate
IUPAC name: copper napthenate
Chemical abstracts name: copper naphthenates ( CAS # 1338-02-9)

Imazalil

Common name: Imazalil
(RS)-1-(β-allyloxy-2,4-dichlorophenylethyl)imidazole; or
allyl (RS)-1-(2,4-dichlorophenyl)-2-imidazol-1-ylethyl ether
Chem abstract name (+/−)-1-[2-(2,4-dichlorophenyl)-2-(2-propenyloxy )ethyl]-1H imidazole
Biocide type: azole

The concentration of RH-287 and synergistic co-biocide (hereafter, for simplicity, both together referred to as “biocide”) in the solution used to treat wood (“treatment solution”) is dependent upon many factors, among them, the wood treatment method and the desired final concentration in the wood.

For example, if the treatment solution is applied using a superficial method of application, such as brushing or spraying, it may be necessary to use a higher biocide concentration to achieve a given degree of preservation in order to compensate for the lack of penetration which would result from high pressure application methods.

Furthermore, the type of wood or wood product may have an effect on the amount of wood preservative needed in the product to achieve a given efficacy. Some woods have lower natural decay resistance than others, and the attainment of a given decay resistance may require that such woods are treated with preservative fluids containing a higher concentration of biocide than woods with higher natural decay resistance.

Furthermore, the intended use of the wood and anticipated types of exposure may be taken into account in determining the appropriate level of biocide in the wood. For example, uses in which the wood is to be exposed to tropical climates, marine environments, ground contact, etc. may accelerate the rate of decay relative to temperate, dry or sheltered, above ground exposures. For instance, timber decay generally proceeds more rapidly in tropical regions than in temperate regions. Furthermore, climatic conditions may influence the types of wood destroying organisms found in any particular region and the rate at which these organisms break down timber will tend to be faster in warmer conditions. Possible exposure environments range from dry, relatively unexposed situations to timber permanently immersed in sea water. To obtain a given degree of protection, higher levels of biocide may be required for timber exposed under tropical conditions than for timber exposed under more temperate conditions.

In general, the final concentration of wood preservative in the wood can be adjusted based on the intended use and exposure of the wood. In most applications, an RH-287 concentration of from 0.0001 to 0.2500 grams per gram of wood or wood product, when expressed in terms of the oven dry weight of timber or other cellulosic material, is sufficient. More preferred is an RH-287 concentration in the range of from 0.0005 to 0.03 grams of RH-287 per gram of wood or other wood product. In additional embodiments, the RH-287 can be present in concentrations in the ranges of from 0.001 to 0.02 or 0.005 to 0.015 grams per gram of wood or wood product. The optimum concentration of RH-287 in the wood can depend upon the timber species to be treated, the exposure and environmental factors, etc. Such optimal concentrations can be determined by one of skill in the art.

The treatment solution can contain the RH-287 and the cobiocide in a wide range of relative concentrations. In one embodiment, the RH-287 and co-biocide components can be present in a range of weight ratios from 0.01 gram of RH-287 per gram of co-biocide to 100 grams of RH-287 per gram of co-biocide. However, it is preferable to have a ratio in the range of from 0.05 to 50 gram of RH-287 per gram of co-biocide. In other embodiments ratio is in the range of from about 0.05 to 20, 0.1 to 10, 0.5 to 1.5, or 0.9 to 1.1.

The concentration of RH-287 and cobiocides in a treatment solution can independently be in the range of from about 0.01 wt % to concentrations as high as 50 wt %. In one embodiment, the level of RH-287 and synergistic co-biocide in a ready-to-use preservative formulation are independently at concentrations in the range of from about 0.01% weight to 25.00% weight. The preferred range is 0.05% weight to 3.0% weight. These percentages apply to normal liquid preservatives, higher percentages may be employed in paste formulations used for remedial treatment of transmission poles and certain other timbers.

In the case of treatments which do not penetrate to the center of the wood, the wood which actually contains the biocide, which is sometimes referred to as the “treated” or “penetrated zone,” is used in the foregoing ratio. The penetrated zone will generally contain the RH-287, the cobiocide, or both, in concentrations of at least 0.0001 grams per gram of wood.

In many instances biocides are supplied as concentrates which are intended to be diluted before use. Supplying in the form of biocide concentrates can reduce the cost of transport and storage. For the purposes of illustration, the ready-to-use formulation is the form in which the wood preservative is applied to timber, with no further dilution or other concentration-altering steps before application. In one embodiment, the level of RH-287 and synergistic co-biocide in the ready to use preservative formulation are independently at concentrations in the range of from about 0.01% weight to 50% weight.

Generally, the more preservative that is retained in a wood or wood product, or other cellulosic material, the longer it will be protected when placed in a situation where biological decay could occur.

The composition of the present invention is effective in preventing decay in a wide variety of wood and wood products. Solid timber of various hardwood and softwood trees can be used. Furthermore, board materials, such as plywood, blockboard, laminates, flakeboard, chipboard and fibreboard, veneers, slices or particles of timber or other cellulosic material held together to form a board or beam as well as other materials produced from timber can be preserved with the composition of the present invention.

In addition to RH-287 and one or more other wood preservative synergistic co-biocide agents provided above, the composition may also contain other additives having biocidal properties.

Additional biocides such as, for example, fungicides and insecticides, may be present as well. Non-limiting examples of fungicides which can be used are azoles, such as, for example tebuconazole, and prochloraz; metal containing fungicides, such as copper- and/or zinc-containing fungicides, such as, for example, zinc soaps, amine copper, copper 8 quinolinolate, tributyl tin compounds; IPBC; quarternary ammonium compounds, strobilurin compounds and boron compounds, such as for example, disodium octaborate and boric acid.

Non-limiting examples of insecticides which can be used are synthetic pyrethroids, such as, for example, permethrin, cypermethrin, and bifenthrin; organophosphates such as, for example, phoxim and chlorpyrifos; chloronicotinyls, such as, for example, imidacloprid; and phenylpyrazoles, such as, for example, fipronil. Other examples of commonly available insecticides which can be used are, chlorfenapyr, clothianidin, etofenprox, and neonicotinoid insecticides such as thiamethoxam, thiacloprid.

The composition of the present invention can be prepared in polar or non-polar solvents, or a mixture of both. The choice of solvent employed generally is dependent upon the solubility properties of RH-287, the co-biocide and whether a solution or an emulsion or a dispersion is desired. Suitable solvents include water, hydrocarbon solvents of both the aliphatic and aromatic types (such as white spirit, odorless kerosene, diesel oil, xylene and toluene), oxygenated solvents (such as alcohols, ketones, esters and glycol ethers), and vegetable oils both processed and natural (such as linseed oil, castor oil and rape seed oil). Blends of oil types may also be used to produce the required properties. Water based systems, including emulsions or dispersions, are preferred. In one embodiment, the solvent is a volatile solvent such as water or white spirit. In another embodiment, the solvent is acetone.

The compositions of the present invention may further comprise additives such as one or more compounds of the following types: water repellents, pigments, dyes, anti-foaming additives, wetting agents or penetration aids. Examples of water repellents which can be used include waxes, wax emulsions and silicones. Coloring agents such as pigments may be added. Examples of such coloring agents include iron oxide type pigments, organic pigments, azo dyes, acid dyes and basic dyes. Anti-foaming agents include siloxanes and other oil soluble surfactants. Wetting agents include a wide range of surfactants. Penetration aides, examples of which include chelating agents, imines and surfactants, can be used, if desired.

Additives such as resins, non-drying co-solvents, water repellents can also be included in the present compositions.

If desired, the RH-287, the synergistic co-biocide component or both can be present in the composition of the present invention as a suspension, emulsion, dispersion, etc. of particles. It is preferred that the average particle size of such a suspension be in the range of from 0.005 to 25 microns.

The compositions of the present invention can be prepared by standard methods. One such method is to dissolve the biocide components in the desired solvent. In another method, RH-287 and/or the synergistic co-biocide components are obtained in particulate form, and a suspension, dispersion or emulsion is formed. In general, both the RH-287 and the synergistic co-biocides can be added to the solvent simultaneously or in either order. If desired, separate solutions containing each component, either fully dissolved or in particulate form, can be prepared and combined.

The biocide mixtures of the present invention can be applied to wood and cellulosic products by a variety of methods including pressure and non pressure methods. Pressure methods include double vacuum impregnation, vacuum pressure impregnation (Full Cell and Empty Cell types) and pressure injection. Non-pressure methods include brushing, coating, spraying, immersion, dipping, steeping, diffusion, and hot and cold open tank methods. In one embodiment, the double vacuum and vacuum pressure methods are used.

With many treatment processes it is preferable that the timber be seasoned or dry before application of the biocidal solution. However, if a diffusion method of application is used, it is preferable that the wood contain a considerable amount of water to allow the RH-287/synergistic co-biocide combination to diffuse into the wood cells.

Wooden posts and poles in damp or wet soil are examples of timber commodities exposed under very severe conditions. With part of the timber below the surface of the soil and part of the timber above ground level there exist a range of micro-environments. Below ground level there will be excess moisture but relatively little oxygen while at the top of the post or pole the tendency will be for the reverse to be true. Normally decay of timber proceeds most rapidly near to the junction of the portion above and below ground level (ground line) where there will be a balance between oxygen and moisture. Field trials have been undertaken in many parts of the world where timber stakes, posts or poles are exposed part buried in the ground.

The present invention also provides a simple exposure test for evaluating the wood preserving abilities of candidate ingredients or compositions. This exposure test is based on the premise that small dimension timber test specimens tend to fail due to decay more quickly than larger ones in soil contact situations.

It is preferable that the thickness of the veneers be greater than 0.1 mm, as veneers of lesser thickness can often be pulled apart by hand without undergoing exposure to decay organisms. Veneers which are thicker than 0.4 may take an excessive amount of time to fail the exposure test. In one embodiment, the thickness of the veneers is about 0.2 mm and the wood is the sapwood of the Scots pine (Pinus sylvestris). Other woods and thicknesses can be used. However, it is preferable that the undecayed veneers do not easily pull apart by hand, or take an excessive amount of time, particularly in the absence of biocide, to fail during the exposure test. For example, 0.2 mm thick Scots pine sapwood veneers which are exposed as outlined below generally fail in 5 weeks or less. An example of convenient width and length dimensions are 15×50 mm. However, width and length are not critical, although very large or small length or width dimensions may be difficult to handle.

Accordingly, the test of the present invention comprises testing the integrity of a veneer after exposure to a decay-inducing environment. In one embodiment, this environment is damp compost in which decay organisms are present and water is present at just above the water holding capacity of the compost. If desired, other media can be used, and the test can be conducted at water contents which are below, at, or above the water-holding capacity of the media.

In general, the integrity of the veneer is inversely related to the length of exposure to the decay promoting environment. The integrity of the veneer can be tested by applying a force to the veneer and noting whether or not the veneer breaks. Thus, if wood preservative agents are applied to the veneers, these veneers would be expected to withstand longer exposure to the environment without breaking compared to control veneers without breaking.

The force applied to the veneers is preferably a force which pulls the two ends in opposite directions. The force can be applied by the use of an instrument or manually. If there is significant decay the veneer will break, generally near the junction between the portion submerged in the decay accelerating medium and the portion exposed to air. If the force is applied manually, it is preferable that the same individual conduct the test at the various exposure time points.

The following examples are provided to further describe the invention and are not intended to be restrictive in any way.

### EXAMPLE 1

This example demonstrates the synergy obtained when RH-287 and synergistic co-biocides are used together. Veneers of Scots pine Pinus sylvestris (0.2 mm thick, 50×15 mm) sapwood are cut from test blocks as described in EN 113, a known standard test method in the European timber industry. The veneers were cut such that both late wood and early wood were present in each veneer. RH-287 was tested in combination with the following biocides: chlorothalonil, fenpropimorph, propiconazole, copper ( as copper naphthenate ), tridemorph, fenarimol, cyproconazole, Imazalil and dichlorophen.

Test solutions were prepared and sets of veneers were dip treated such that there were 6 replicate veneers for each treatment under investigation. Additionally six veneers were dip treated in deionised water to act as water controls. Being thin, the timber veneers dried quickly. Plastic containers (approximately 350×220 mm by at least 60 mm high) were part filled with John Innes Number 2 potting compost at a little above its water holding capacity. The veneers for a particular test were placed in six rows within a container such that approximately half the veneer was below the compost and half above. The veneers were placed in the compost such than those given a particular treatment were distributed throughout the container and were not grouped together. The containers, compost and veneers were weighed then incubated at about 30° C. and near 100% relative humidity in an incubator. Each week during the test the assembly was reweighed and deionised water added to bring it back to its original mass. After 3 weeks each veneer was examined in turn. It was held between the fingers at each end and pulled to see if it could be broken. If it could be pulled apart a failure was recorded. If the veneer was sound, this was recorded and the veneer was returned to its original position. After a further one week incubation all sound veneers were assessed again as described above, with the same person conducting the assessments. The assessments continued until all veneers in the container failed. From the results, the average life in weeks were calculated for the water control veneers or veneers treated with a particular composition. The results are presented below.

In the first test each of the above five formulations were tested and also mixtures such that 50% of the RH-287 test fluid was added to 50% of the other test fluids. The combinations tested are illustrated in the table below:

TABLE 1
As solutions in acetone

| Fungicide | No addition | With RH-287 added |
|---|---|---|
| Chlorothalonil | 2.00% Chlorothalonil | 1.00% Chlorothalonil |
| | | 1.00% RH-287 |
| Fenpropimorph | 2.00% Fenpropimorph | 1.00% Fenpropimorph |
| | | 1.00% RH-287 |
| Propiconazole | 2.00% Propiconazole | 1.00% Propiconazole |
| | | 1.00% RH-287 |
| Copper (as Cu Naph) | 2.00% Copper | 1.00% Copper |
| | | 1.00% RH-287 |
| Tridemorph | 2.00% Tridemorph | 1.00% Tridemorph |
| | | 1.00% RH-287 |
| Fenarimol | 2.00% Fenarimol | 1.00% Fenarimol |
| | | 1.00% RH-287 |
| Cyproconazole | 2.00% Cyproconazole | 1.00% Cyproconazole |
| | | 1.00% RH-287 |
| Imazalil | 2.00% Imazalil | 1.00% Imazalil |
| | | 1.00% RH-287 |
| Dichlorophen | 2.00% Dichlorophen | 1.00% Dichlorophen |
| | | 1.00% RH-287 |
| RH-287 | 2.00% RH-287 | — |

The above 19 formulations were used to treat sets of veneers as described above. Acetone was also used to prepare acetone controls. The average half lives for each treatment were calculated. To illustrate the way in which half lives were calculated the following example is provided:

In the case of the six replicate veneers treated with 2% Chlorothalonil no veneers failed before the 11 week inspection, two veneers failed at the 11 week inspection, three veneers failed at the 13 week inspection, and one veneer failed at the week 14 inspection. The following six values represent the time (in weeks) when failures occurred 11, 11, 13, 13, 13, and 14 These values were added together (75) and divided by six to give an average of 12.5 weeks. This value of 12.5 is the average time, in weeks, for failure to occur. The equivalent average times for failure to occur for the other treatments examined in test 1 are presented in Table 2. The comparative value for acetone controls was 4.5.

TABLE 2
Half lives for chemicals tested as solutions in acetone

| | | With RH-287 added |
|---|---|---|
| | | (expected value in |
| Fungicide | No addition | parentheses) |
| Chlorothalonil | 12.50 weeks | 22.50 weeks |
| | | (18.84 weeks) |
| Fenpropimorph | 4.50 weeks | 21.17 weeks |
| | | (14.84 weeks) |
| Propiconazole | 4.50 weeks | 20.50 weeks |
| | | (14.84 weeks) |
| Copper (as Copper | 16.67 weeks | 21.50 weeks |
| Naphthenate) | | (20.92 weeks) |
| Tridemorph | 4.33 weeks | 17.50 weeks |
| | | (14.75 weeks) |
| Fenarimol | 5.50 weeks | 17.17 weeks |
| | | (15.34 weeks) |
| Cyproconazole | 5.17 weeks | 22.00 weeks |
| | | (15.17 weeks) |
| Imazalil | 7.00 weeks | 18.50 weeks |
| | | (16.09 weeks) |
| Dichlorophen | 16.00 weeks | 24.17 weeks |
| | | (20.59 weeks) |
| RH-287 | 25.17 weeks | — |

From the above table it can be seen that the average time for failure to occur for veneers treated with 2.00% chlorothalonil is 12.5 weeks and for veneers treated with 2.00% RH-287 is 25.17 weeks. If 1.00% chlorothalonil and 1.00% RH-287 are combined (half the amount of each biocide) it is expected that, if the effect is additive, the resultant average time for failure to occur should be midway between 12.5 and 25.17 weeks, namely about 18.84 weeks. However, when the combination of 1.00% chlorothalonil and 1.00% RH-287 was actually tested the average time for failure to occur was found to be 22.50 weeks. Any such increase in performance is termed here as positive synergy in the context of this patent. In the above table, expected average times for failure to occur for each combination of biocides are shown in parentheses. These expected average times for failure to occur have been calculated as described above. These calculated values have been rounded up to the first place of decimals, where necessary.

It is surprising that in all instances where RH-287 is one of the biocides in the combination the actual average time to failure found by testing is greater than the estimated one shown in the table above. The effect appears most marked when RH-287 is combined with fenpropimorph or cyproconazole but is also evident when RH-287 is combined with the other biocides. These results demonstrate positive synergy according to the definition provided earlier.

### EXAMPLE 2

This example demonstrates the synergistic effect of RH-287 with the wood protectant imazalil. The Exposure test was performed and half-lives were calculated as in Example 1. The biocides were formulated as set forth in Table 3 (all the percentages are mass/mass):

TABLE 3
Solutions in acetone

| Fungicide | No Addition | With RH-287 |
|---|---|---|
| Imazalil | 2.00% Imazalil | 1.00% Imazalil |
| | | 1.00% RH-287 |
| RH-287 | 2.00% RH-287 | Not applicable |

Calculated half lives derived from the soil contact veneer tests are summarized in Table 4.

TABLE 4
Half lives for solutions in acetone

| | | Half life for 1.00% |
|---|---|---|
| | Half life for fungicide at | fungicide plus 1.00% RH- |
| | 2.00% active ingredient | 287 (expected value in |
| Fungicide | (ai) | parentheses) |
| Imazalil | 7.67 weeks | 19.33 weeks |
| | | {15.09 weeks} |
| RH-287 | 22.50 weeks | Not applicable |

### EXAMPLE 3

This example demonstrates the synergistic effect of RH-287 with dichlorophen. The Exposure test was performed and half-lives were calculated as in Example 1. The biocides were formulated as set forth in Table 5 (all the percentages are mass/mass):

TABLE 5
Solutions in acetone

| Fungicide | High level | Low level | With RH-287 |
|---|---|---|---|
| Dichlorophen | 1.6% | 0.8% | 0.8% Dichlorophen |
| | Dichlorophen | Dichlorophen | 0.08% RH-287 |
| RH-287 | 1.6% RH-287 | 0.8% RH-287 | Not applicable |

Calculated half lives derived from the soil contact veneer tests are summarized in Table 6.

TABLE 6
Half lives for solutions in acetone

| | Half life | Half life | Half life for 0.8% |
|---|---|---|---|
| | for fungicide | for fungicide | fungicide plus 0.8% |
| | at 1.60% active | at 0.8% active | RH-287 (expected |
| Fungicide | ingredient (ai) | ingredient | value in parentheses) |
| Dichlorophen | 10.83 weeks | 8.67 weeks | 15.33 weeks |
| | | | {13.83 weeks} |
| RH-287 | 16.83 weeks | 10.00 weeks | Not applicable |

### EXAMPLE 4

This example demonstrates the synergistic effect of RH-287 with imazalil. The Exposure test was performed and half-lives were calculated as in Example 1. The biocides were formulated as set forth in Table 7 (all the percentages are mass/mass):

TABLE 7
Solutions in acetone

| Fungicide | High level | Low level | With RH-287 |
|---|---|---|---|
| Imazalil | 1.6% Imazalil | 0.8% Imazalil | 0.8% Imazlil |
| RH-287 | 1.6% RH-287 | 0.8% RH-287 | Not applicable |

Calculated half lives derived from the soil contact veneer tests are summarized in Table 8.

TABLE 8
Half lives for solutions in acetone

| | Half life | Half life | Half life for 0.8% |
|---|---|---|---|
| | for fungicide | for fungicide | fungicide plus 0.8% |
| | at 1.60% active | at 0.8% active | RH-287 (expected |
| Fungicide | ingredient (ai) | ingredient | value in parentheses) |
| Imazalil | 6.17 weeks | 5.50 weeks | 15.17 weeks |
| | | | {11.42 weeks} |
| RH-287 | 16.67 weeks | 12.17 weeks | Not applicable |

### EXAMPLE 5

This example describes the relationship between the concentration of active RH-297 and veneer half life. For this example RH-287 was dissolved in acetone to give different concentrations. Veneers were dip treated, dried, exposed to compost and tested as described in Example 1. The calculated half lives based on the time point at which the veneers broke is presented in Table 9

TABLE 9

| Fluid Ref. | | |
|---|---|---|
| number | % active RH-287 | Calculated Half |
| Fluid 1 | 0% RH-287 (Acetone) | 4.33 weeks |
| Fluid 2 | 0.125% RH-287 | 7.33 weeks |
| Fluid 3 | 0.25% RH-287 | 7.67 weeks |
| Fluid 4 | 0.50% RH-287 | 10.67 weeks |
| Fluid 5 | 1.00% RH-287 | 13.83 weeks |
| Fluid 6 | 1.50% RH-287 | 18.67 weeks |
| Fluid 7 | 2.00% RH-287 | 20.33 weeks |
| Untreated | — | 4.50 weeks |

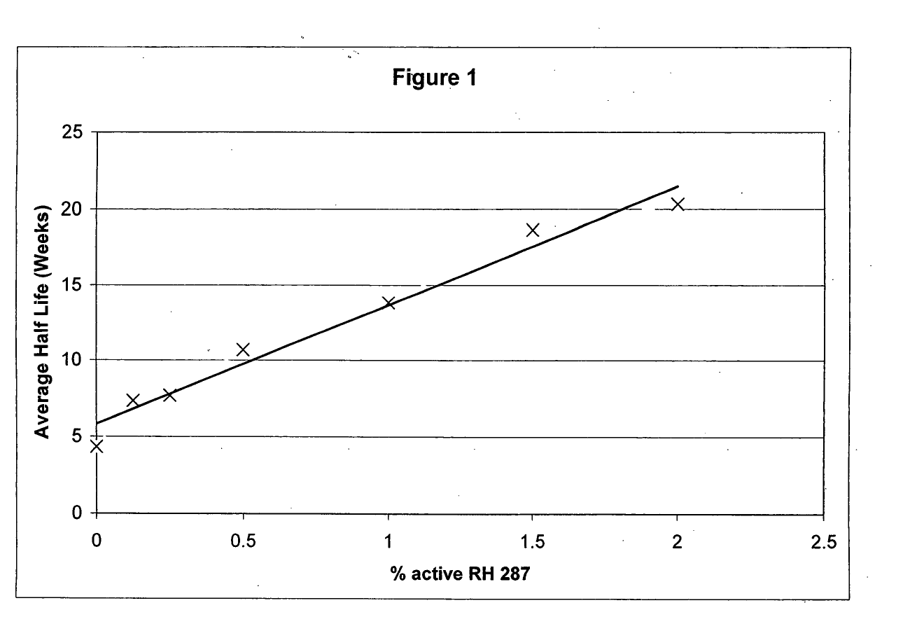

These data indicate that with increasing concentration of RH-287, a corresponding increase in the half life is observed at least up to about 2% RH-287 (FIG. 1).

While specific examples have been presented to illustrate the invention, those skilled in the art will recognize that routine modifications can be made to the compositions and methods described herein which are intended to be within the scope of the present invention.

We claim:

1. A composition comprising:
a) RH-287
b) a co-biocide; and
c) a solvent;
wherein the RH-287 and the co-biocide are present in a weight ratio in the range of from 0.05 to 50 grams of RH-287 per gram of co-biocide.

2. The composition of claim 1 wherein the RH-287 comprises between 0.01 and 25 wt % of the composition.

3. The composition of claim 1 wherein the co-biocide is selected from the group consisting of dichlorophen, fenarimol, tridemorph, fenpropimorph, cyproconazole, propiconazole, chlorothalonil, copper naphthenate, and imazalil.

4. The composition of claim 1 wherein the solvent is water, acetone an aliphatic or aromatic hydrocarbon, an oxygenated solvent, or a processed or natural vegetable oil.

5. The composition of claim 4 wherein the solvent is selected from the group consisting of white spirit, odorless kerosene, diesel oil, xylene, toluene, an alcohol, a ketone, an ester, a glycol ether, linseed oil , castor oil and rape seed oil.

6. The composition of claim 1 wherein the RH-287, the co-biocide, or both are micronized.

7. A method for preserving wood comprising the step of applying a composition to wood, said composition comprising:
a) RH-287
b) a co-biocide; and
c) a solvent;
such that the combination of the RH-287 and co-biocide is synergistic with respect to the half life of the wood.

8. A method as in claim 7 wherein the RH-287 and co-biocide in the composition applied to the wood are present in the composition a weight ratio in the range of from 0.05 to 50 grams of RH-287 per gram of co-biocide.

9. A method as in claim 7 wherein said composition is applied to a concentration of from 0.0001 to 0.25 grams per gram of wood.

10. A method as in claim 9 wherein the co-biocide in the composition applied to the wood is selected from the group consisting dichlorophen, fenarimol, tridemorph, fenpropimorph, cyproconazole, propiconazole, chlorothalonil, copper naphthenate, and imazalil.

11. A method as in claim 7 wherein the solvent in the composition applied to the wood is selected from the group consisting of water, an aliphatic or aromatic hydrocarbon, an oxygenated solvent, or a processed or natural vegetable oil.

12. A method as in claim 7 wherein the solvent in the composition applied to the wood is selected from the group consisting of white spirit, odorless kerosene, diesel oil, xylene, toluene, an alcohol, a ketone, an ester, a glycol ether, linseed oil , castor oil and rape seed oil.

13. A method as in claim 7 wherein the wherein RH-287, the co-biocide, or both in the composition applied to the wood are micronized.

14. A method as in claim 13 wherein the composition is applied by impregnation.

15. Wood which has been treated with a composition comprising:
a) RH-287; and
b) a co-biocide;
wherein a) and b) are present in the composition in a weight ratio in the range of from 0.05 to 50 grams of RH-287 per gram of co-biocide.

16. The wood of claim 15 wherein the RH-287 comprises between 0.01 and 25 wt % of the composition.

17. The wood of claim 16 wherein said composition comprises a co-biocide is selected from the group consisting of dichlorophen, fenarimol, tridemorph, fenpropimorph, cyproconazole, propiconazole, chlorothalonil, copper naphthenate, and imazalil.

18. Wood as in claim 17 wherein said composition is applied to a concentration of from 0.0001 to 0.25 grams per gram of wood.

19. Wood as in claim 17 wherein the solvent in the composition applied to the wood is selected from the group consisting of white spirit, odorless kerosene, diesel oil, xylene, toluene, an alcohol, a ketone, an ester, a glycol ether, linseed oil, castor oil and rape seed oil.

20. Wood as in claim 17 wherein RH-287 is present in the wood in a weight ratio in the range of from 0.05 to 50 grams of RH-287 per gram of co-biocide.
